(19) United States
(12) Patent Application Publication
(10) Pub. No.: US 2009/0136616 A1
(43) Pub. Date: May 28, 2009

(54) METHODS OF FEEDING RUMINANTS ON WINTER FORAGE SUPPLEMENTING WITH ZEOLITE

(76) Inventor: Kenneth S. Eng, San Antonio, TX (US)

Correspondence Address: BOOTH ALBANESI SCHROEDER LLC, 1601 ELM STREET, SUITE 1950, DALLAS, TX, 75201-4744, US

(21) Appl. No.: 12/263,102

(22) Filed: Oct. 31, 2008

Related U.S. Application Data
(63) Continuation-in-part of application No. 11/769,473, filed on Jun. 27, 2007.

(51) Int. Cl. A23K 1/175; A23K 1/18

(52) U.S. Cl. 426/2

(57) ABSTRACT

A method of feeding a ruminant is provided. The method includes the steps of: (a) providing a ruminant a grazing time on a winter forage; and (b) during the grazing time, providing the ruminant a mineral supplement comprising a zeolite.

### CROSS-REFERENCE TO RELATED APPLICATIONS

This application is a continuation-in-part of U.S. Ser. No. 11/769,473, filed Jun. 27, 2007.

### STATEMENT REGARDING FEDERALLY SPONSORED RESEARCH OR DEVELOPMENT

Not applicable.

### REFERENCE TO MICROFICHE APPENDIX

Not applicable.

### I. SUMMARY OF THE INVENTION

A method of feeding a ruminant is provided. The method includes the steps of: (a) providing a ruminant a grazing time on a winter forage; and (b) during the grazing time, providing the ruminant a mineral supplement comprising a zeolite.

According to another aspect of the invention, a different method of feeding a ruminant is provided. This method includes the steps of: (a) forming an animal feed ration comprising a zeolite, wherein the animal feed ration has less than 25 gram monensin sodium (e.g., Rumensin®) per ton (12.5 mg/lb), and wherein the animal feed ration has less than 8 gram tylosin phosphate (e.g., Tylan®) per ton (4 mg/lb); and (b) feeding the animal feed ration to a ruminant. In the animal feed ration means with the feed as opposed to in the supplement portion of the diet fed separately, whereby the zeolite is simultaneously ingested with the feed. Preferably, the zeolite comprises a clinoptilolite zeolite, and more preferably the clinoptilolite zeolite comprises a calcium clinoptilolite zeolite.

According to yet another aspect of the invention, a method of feeding a ruminant includes the steps of: (a) forming an animal feed ration comprising: (i) a processed grain by-product having a high sulfur concentration greater than 0.3% by weight on a dry matter basis (“DMB”); (ii) a clinoptilolite zeolite; and (b) feeding the animal feed ration to a ruminant. Preferably, the clinoptilolite zeolite comprises a calcium clinoptilolite zeolite. A suitable calcium clinoptilolite zeolite is commercially available under the trade name Biolite®.

On a worldwide basis, there has been considerable research on a variety of applications for zeolites, but results are sometimes misleading. This is at least partially because the general term zeolite is often used to describe materials with vastly different characteristics and efficacy. There are a variety of uses for zeolites including air and water filtration, environmental clean up involving heavy metals and radio active contamination, a soil amendment for golf courses, greenhouses, etc., cat litter, paper production, etc. It is also used in feed as a pellet binder, flow agent, to improve ammonia utilization, bind toxins and heavy metals, a buffering agent, and for reducing bloat and metabolic problems.

As used herein, the words “comprise,” “has,” and “include” and all grammatical variations thereof are each intended to have an open, non-limiting meaning that does not exclude additional elements or steps.

Other and further aspects and advantages of the present inventions will be apparent to those of skilled in the art upon reviewing the following detailed description.

### II. BRIEF DESCRIPTION OF THE DRAWING

The accompanying drawing is incorporated into and forms a part of the specification. The drawing together with the description serves to explain the inventions. The drawing is only for illustrating a preferred and alternative example of how the inventions can be made and used and is not to be construed as limiting the inventions to the illustrated and described example. Certain advantages of the present inventions will be apparent from a consideration of the drawing in which:

FIG. 1 is a graph of fermentation pH as effected by various treatments of a control diet, the control diet Biolite, and control diet with both Biolite® and Brucite;

FIG. 2 is a chart of lagoon ammonia emissions showing that the Rumensin®-Tylan® (“RumTy”) diet without the inclusion of zeolite released more ammonia quicker than any of the following diets: (a) a diet with calcium clinoptilolite zeolite (Biolite®) and Nova-Cell® and Ruma-Just® (“NovaRumJu”) but without any Rumennsin®-Tylan®; (b) a diet with calcium clinoptilolite zeolite (Biolite®) and with Rumensin, Nova-Cell®, and Ruma-Just® (“RumNovRuJu”) but without any Tylan®; and (c) a diet a diet with calcium clinoptilolite zeolite (Biolite®), and with a half-concentration of Rumensin®, Nova-Cell® and Ruma-Just® (“HalfRumNovRu”) but without any Tylan®.

### III. DETAILED DESCRIPTION OF THE INVENTION

### A. Comparing Steam-Flaked Grain to Steeped-Cracked Grain in High-Corn Finish Diets for Yearling Cattle, Including Comparing Biolite® in Place of Monensin Sodium or Tylosin Phosphate

### i. Introduction

Fuel prices have reached new highs and it is projected that the future holds more of the same. This is likely to impact the cattle feeding industry in at least two ways.

First, there will be increase in ethanol production from corn and as a result, a large increase in the distiller's grains by-products of corn ethanol production. Research has shown that corn distiller's grains, especially in the wet form has a very high feeding value due to its protein, fat and possibly unidentified grown factor (UGF) content.

Increased energy price will also increase the cost of steam flaking corn and feedlots may search for other ways to process grain. Because the wet distiller's grain material may be high in various enzymes, yeast, and other microbial products, it's possible that steeping cracked corn in the wet distiller's grains prior to feeding could increase corn starch digestibility without steam flaking.

For these reasons, an experiment was designed comparing the steam flaked grain to steeped cracked grain in high corn finish diets for yearling cattle. In addition, previous research has indicated the use of a calcium clinoptilolite zeolite (Biolite®) may improve performance in natural diets and or medicated diets without Monensin sodium and Tylosin phosphate (“RT”). A factorial experimental design will be used to also compare Biolite® (“BL”) in place of RT or Tylosin phosphate (“T”) in these diets.

### ii. Experimental

The experimental cattle were English Cross yearling heifers and steers from Western Canada. Upon arrival, they were given routine vaccination and treatments for internal and external parasites. In addition, the steers received Revalor S and the heifers Revalor H implants.

After they were started on feed they were randomly allotted to treatments shown in Table A-1. The cracked corn was steeped 24 hours in a mixture containing cracked corn plus wet distiller's grain.

The experimental design and data to be collected is shown in Tables A-1 & A-2. Because it was not possible to slaughter all of the experimental cattle at one plant, it was decided the only carcass data collected was liver abscesses. Tables A-3 & A-4 are the ration and premix formulas. Performance results are shown in Tables A-5 & A-6.

### iii. Results and Discussion

The results of the corn processing comparisons are shown in Table A-5. There were no significant differences in consumption, gain or conversions. However, because of the reduced cost of steeping corn compared to flaking, the gain cost of the steep cracked corn treatment was significantly less than the steam flaked treatment. The effect of ration additives on performance is shown in Table A-6. Because there were no significant performance differences due to corn processing, the processing reps were combined for each ration treatment making a total of 8 reps per treatment. Treatment 3 which was the natural diet plus BL gained significantly faster than treatments 1 & 2. There was no feed consumption difference between treatments. The conversions tended to be better in treatment 3 vs. treatment 1 & 2 and this difference approached significance (P.17).

Rumen pH was higher for treatment 3 compared to treatment 1 and intermediate for treatment 2. There was only 1 liver abscess in treatment 1 and no liver abscesses in Treatment 2 or 3. This is unusually low and would indicate that either the Tylosin phosphate or Biolite® were effective at preventing abscesses.

### iv. Summary

Steep cracked corn was equal to steam flaked corn in terms of performance. Because of lower processing cost the steep cracked corn diet was more economical than the steam flaked corn diet.

Performance in treatment 3 with no drug additives plus BL was better than treatments 1 & 2. Rumen pH in treatment 3 was also higher than treatment 1 and as Treatment 2 pH intermediate. It appeared that either Tylosin phosphate or Biolite® was equally effective at preventing liver abscesses.

TABLE A-1
Experimental Treatments
TREATMENTS

| | |
|---|---|
| 1 | Steam Flaked corn + Monensin sodium & Tylosin phosphate (“RT”) |
| 2 | Steam Flaked Corn + Monensin sodium (“R”) + Biolite ® (“BL”) |
| 3 | Steam Flaked Corn + BL |
| 4 | Cracked corn + RT |
| 5 | Cracked corn + R + BL |
| 6 | Cracked corn + BL |

TABLE A-2
Experimental Animals & Data Measured
Experimental Cattle (168 head) - Yearlings -
English Cross Heifers & Steers 24 Pens -
Reps of 7 head each/treatment (12 pens Steers, 12 pens of Heifers)
Data Measured

| | |
|---|---|
| 1) | Gain, consumption, conversion at 28 day intervals and overall |
| 2) | Liver abscesses |
| 3) | Rumen pH |

| 12 pens | | | 12 pens | | |
|---|---|---|---|---|---|
| S.F. Corn | | | S. Ck. Corn | | |
| RT | R + BL | BL | RT | R + BL | BL |

TABLE A-3
Experimental Finish Ration

| | D.M.B |
|---|---|
| INGREDIENTS** | |
| Corn (82% D.M.) | 75.0% |
| Wet Distillers (30% D.M.) | 10.00 |
| Corn Silage (30% D.M.) | 08.00 |
| Premix | 07.00 |
| | 100.0% |
| ESTIMATED ANALYSIS (D.M.B) | |
| Protein (%) | 13.50 |
| NPN (%) | 02.80 |
| Fat (%) | 03.80 |
| Fiber (%) | 05.00 |
| Calcium (%) | 00.60 |
| Phosphorus (%) | 00.33 |
| NE m (megacals) | 104.00 |
| NE p (megacals) | 64.00 |

*Zeolite added at 1.2% (D.M.B) in place of corn in experimental diets
**Cracked corn and wet distiller's grain combined & steeped 24 hrs before feeding

TABLE A-4
Experimental Premix

| | Amount | |
|---|---|---|
| Ingredients | | |
| Wheat Shorts | 53.3% | |
| Limestone | 21.40 | |
| Urea | 15.30 | |
| Salt | 03.60 | |
| Potassium Chloride | 05.00 | |
| Dical Phosphate | 00.00 | |
| Mag. Oxide | 01.40 | |
| Ammonium Sulfate | 00.00 | |
| | 100.0% | |
| Additives | | |
| Vitamin A | 40,000 | IU/lb. |
| Vitamin D | 4,000 | IU/lb. |
| Vitamin E | 40 | IU/lb. |
| Selenium | 2.0 | mg/lb. |
| Trace Mineral Premix* | 6 | lb/ton |

*Trace Mineral Premix

| | |
|---|---|
| Zinc Sulfate | 59.3% |
| Manganese Sulfate | 20.30 |
| Copper Sulfate | 18.80 |
| Cobalt | 01.20 |
| EDDI | 00.40 |
| | 100.0% |

TABLE A-5
Experimental Treatments
Treatments

| | |
|---|---|
| 1. | Steam Flaked Corn + Monensin sodium & Tylosin phosphate (“RT”) |
| 2. | Steam Flaked Corn + Monensin sodium (“R”) + Biolite ® (“BL”) |
| 3. | Steam Flaked Corn + BL |
| 4. | Cracked Corn + RT |
| 5. | Cracked Corn + R + BL |
| 6. | Cracked Corn + BL |

TABLE A-6
COUNT, S/B “5”
Final Performance - 112 days

| Treatment | | |
|---|---|---|
| 1 | 2 | 3 |
| RT | R + BL | Nat. - 0 + BL (only) |

0-112 Days

| | | | |
|---|---|---|---|
| ADG | 3.52a | 3.56a | 3.87b |
| FI | 25.1 | 25.5 | 25.9 |
| CONV. | 7.21 | 7.22 | 6.71 |
| Rumen ph | 6.35a | 6.45ab | 6.75b |
| Liver AB | 1.8 | 0.0 | 0.0 |

Means within Rows with unlike subscripts differ (<.05)
8 reps of 7 head per treatment
Experimental Animals - 800 wt. English/Exotic Steers & Heifers
Diet-High concentrate-SF corn, wet distillers, silage & premix
Treatment 1 RT - Monensin sodium-Tylosin phosphate
Treatment 2 R + BL - Monensin sodium + Biolite ®
Treatment 3 BL (Biolite ® Only (natural))

| Additives | Treatment 1 | Treatment 2 | Treatment 3 |
|---|---|---|---|
| Monensin sodium | Yes | Yes | No |
| Tylosin phosphate | Yes | No | No |
| Biolite ® | No | Yes | Yes |

### B. The Use of Biolite® (A Calcium Clinoptilolite Zeolite) in Diets for Natural Beef Production

### i. Introduction

Natural beef production requiring non-medicated (n-med) diets is becoming more popular in the United States. Conventional U.S. feedlot diets normally contain low levels of ionophores and other antibiotics. It is thought these additives improve performance, prevent subclinical acidosis and metabolic problems, and reduce liver abscesses. In recent years we have conducted a number of studies comparing various zeolites in med and n-med high concentrate finishing diets. These diets have been composed of corn silage for roughage, flaked corn, and a substantial amount of wet corn milling byproducts.

The feed additives used included Monensin sodium (R) and Tylosin phosphate (T). Previous studies indicated a particular calcium clinoptilolite zeolite (i.e., Biolite®) (B) gave the most favorable results when included in experimental diets at 1.2% (DMB) in place of an equivalent amount of corn. Our experiences would indicate the majority of other zeolites tested have limited value in feedlot rations.

Data collected included daily gain, consumption, feed efficiency, rumen pH and observations on bloat and metabolic problems. Carcass data including liver abscess occurrence were collected. Also, the impact of B on the loss of ammonia from feedlot lagoons was measured. This information is a summary of data from seven separate experiments.

Table B-1 shows the impact of the various treatments on rumen pH. Rumen samples were collected from cattle prior to the morning feeding using a Geishauser Probe. The results indicate that the addition of B to either med or n-med rations significantly increased rumen pH.

The incidence of total liver abscesses and A+ abscesses is shown in Table B-3. There were no significant differences in total liver abscesses; however, RTB treatment tended to have the lowest total abscess level. The number of A+ abscesses with the RTB treatment had a significantly lower level of 2.2%. It is possible that these differences in A+ abscesses may relate to the rumen buffering effect of the B.

Ammonia air emission from confined feeding operations is a potential environmental problem throughout the world. It is estimated that 75% of the total ammonia emissions originate from confined feeding operations. Previous research has indicated that certain zeolites, including B, added to feedlot diets can reduce manure ammonia losses. In the following study, manure was collected from animals fed diets containing RT, RT+B, 0 additives, and 4+B. Using experimental lagoons, ammonia emissions were measured over a 28-day period. The results are shown in Table B-3. Treatments 2 and 4, which is manure from rations containing B, had significantly lower ammonia emissions compared to manure from rations without B.

Production of ethanol, fructose etc., from corn has increased dramatically, and as a result, there is a tremendous amount of wet gluten and distillers available for the cattle-feeding industry. Because of the interest in feeding wet corn, byproducts, and natural beef production, we have conducted seven trials using a wet-corn byproduct diet and comparing medicated diets, med. diets+B, and n-med diets+B. Initially, non-med diets without B were also tested, but because of frequent metabolic problems, this treatment was discontinued. Table B-4 contains the average performance on cattle receiving 1) med diets, 2) med diets+B, and 3) non-med diets+13. There were seven separate trials, and in each individual trial there were significant performance differences. Biolite® tended to improve the performance of cattle receiving med diets and non-med diets+B, Monensin sodium is known to decrease the incidence of subclinical acidosis in cattle fed high concentrate diets, and it would appear that B may serve the same function. The impact of B on rumen pH and liver abscesses would tend to confirm this. In summary, the addition of B to rations (1.2% DMB⁻increases rumen pH, decreases the incidence of A+ liver abscesses, and improves performance-especially in non-med finish rations. Probably because of B's affinity for ammonia, manure from diets containing B reduced ammonia emissions from experimental feedlot lagoons.

TABLE B-1
Effect of Biolite ® treatment on rumnen pH

RT 6.42b
R 6.43b means with different super script letter differ, P < .OS O 6.46b
RTB 6.63a RB 6.65a OB 6.66a
*Sample collected by Geishauser Probe

TABLE B-2
Effect of ration treatment on total liver abscesses

| Total Liver Abscess | A + Liver Abscess |
|---|---|
| RT 19.1% | 8.6b % |
| RTB 16.1 | 2.2a |
| RB 20.8 | 5.7ab |
| 013 19.3 | 5.1ab |
| 0 27.7 | 7.9ab |

TABLE B-3
Feedlot lagoon ammonia emissions (PPM)

| Treatment Day | RT | RTB | 0 | 0 B |
|---|---|---|---|---|
| 1 | 0 | 0 | 0 | 0 |
| 7 | 7 | 2 | 9 | 4 |
| 14 | 161 | 93 | 127 | 101 |
| 18 | 200 | 146 | 200+ | 167 |
| 21 | 200 | 144 | 189 | 150 |
| 24 | 183 | 126 | 167 | 104 |
| 28 | 22 | 9 | 47 | 10 |

TABLE B-4
Feedlot performance

| | 1 | 2 | 3 |
|---|---|---|---|
| Treatment | RT | RT + B | B |
| ADG (kg/d) | 1.53 | 1.61 | 1.69 |
| Consumption (kg/d) | 9.9 | 10.0 | 10.2 |
| Feed/gain | 6.33 | 6.09 | 6.02 |

### ii Materials and Methods

Animals, diets, and treatments. Four crossbred steers were used in 4×4 Latin square design balanced for residual effects. The diet consisted of a 93% concentrate (steam-flaked corn-based), and was fed once daily promptly at 8:00 AM. Steers were offered ad libitum amounts of feed. Treatments consisted of the following:

1) negative control with no Monensin sodium/Tylosin phosphate diet (CON)

2) 100% Biolite® included in diet at 1.25% of DM (Bio)

3) 50% Biolite® and 50% Brucite included at 1.25% of DM (Mix)

4) positive control with Monensin sodium/Tylosin phosphate included at 30/10 g/Ton (RT)

Experimental periods and sampling. Experimental periods consisted of 14-d. On d 14 at 8:00 AM (before morning feeding), 10:00 AM, 12:00 PM, 2:00 PM, 4:00 PM, and 8:00 PM rumen pH measurements were made in vivo using an Oakton Waterproof pH/CON 10 Meter (Model WD-35630-62) with a submersible probe. Following pH measurements, rumen fluid (100 mL) was collected and strained immediately. Ruminal fluid samples (8 mL) were then acidified with 2 mL of 25% (wt/vol) meta-phosphoric acid and stored frozen (−20° C.). Frozen ruminal fluid samples were thawed, centrifuged (39,000×g for 20 min, 4° C.), and the supernatant collected for analysis of VFA and ammonia N.

Statistics. Data were analyzed as a 4×4 Latin square design balanced for residual effects with a repeated measures component using the MIXED procedure of SAS. Treatment, time, and their interaction were included in the model statement. The random statement included steer and period, and steer nested in treatment was included as the subject in the repeated statement. When the overall F statistic for a particular variable of interest was significant (P≦0.05) treatment means were separated and compared on a pair-wise basis using the pdiff option in the lsmeans statement. In addition, pre-planned orthogonal contrasts were completed for: 1) CON vs. the rest of the treatments, 2) RT vs. Bio & Mix, and 3) Bio vs. Mix. The Area under the curve (AUC) was calculated to quantify the magnitude of ruminal buffering capacity of each treatment by the equation Σ[((pHₓ+pHₓ₊₁)/2)×(Tₓ₊₁−Tₓ), where pHₓ+pHₓ₊₁ are consecutive pH measurements and Tₓ₊₁−Tₓ is the time interval between measurements. Likewise, the AUC for pH<5.6 was calculated to quantify the severity of subacute acidosis by the equation Σ[(5.6−((pHₓ+pHₓ₊₁)/2))×(Tₓ₊₁−Tₓ) where the values are the same as before. For AUC pH<5.6, only positive values were utilized, indicating the average pH registered below 5.6.

TABLE B-4
Effects of various buffers on measured and calculated rumen parameters

| | | | | | | | Contrasts | | |
|---|---|---|---|---|---|---|---|---|---|
| | | | | | | | CON | RT vs. | |
| | Treatments^{a} | | | | | | vs. | Bio + | Bio vs. |
| Item | CON | Bio | Mix | RT | SE^{b} | P > F^{c} | Others | Mix | Mix |
| Rumen pH | 5.62^{d} | 5.75^{e} | 5.73^{e} | 5.62^{d} | 0.09 | 0.05 | 0.07 | 0.02 | 0.76 |
| Rumen | 126.85 | 104.18 | 109.67 | 84.27 | 27.28 | 0.28 | 0.14 | 0.22 | 0.79 |
| Metabolites, | | | | | | | | | |
| ppm | | | | | | | | | |
| Ammonia N | | | | | | | | | |
| Acetic | 2833.82 | 2850.00 | 2656.25 | 2611.67 | 97.42 | 0.16 | 0.21 | 0.19 | 0.13 |
| Acid | | | | | | | | | |
| Propionic | 2814.47 | 2490.29 | 2331.92 | 2573.29 | 260.46 | 0.47 | 0.19 | 0.54 | 0.61 |
| Acid | | | | | | | | | |
| Butyric | 1005.10 | 900.71 | 944.42 | 816.17 | 125.31 | 0.60 | 0.33 | 0.41 | 0.76 |
| Acid | | | | | | | | | |
| 2-Methyl- | 150.19 | 164.67 | 233.79 | 125.18 | 32.74 | 0.13 | 0.47 | 0.07 | 0.13 |
| Butyric | | | | | | | | | |
| Acid | | | | | | | | | |
| Isobutyric | 49.78 | 56.60 | 52.35 | 35.31 | 7.71 | 0.18 | 0.83 | 0.04 | 0.65 |
| Isovaleric | 50.65^{d} | 95.30^{e} | 55.36^{d} | 27.23^{d} | 16.21 | 0.02 | 0.53 | 0.01 | 0.04 |
| Valeric | 200.48 | 308.75 | 218.65 | 224.13 | 58.26 | 0.11 | 0.17 | 0.28 | 0.06 |
| Area Under | | | | | | | | | |
| Curve, pH × H | | | | | | | | | |
| Total | 66.59^{d} | 68.25^{e} | 68.38^{e} | 66.23^{d} | 1.20 | 0.005 | 0.02 | 0.002 | 0.74 |
| pH < 5.6 | 1.86^{d} | 0.58^{f} | 0.68^{ef} | 1.64^{de} | 0.48 | 0.04 | 0.04 | 0.05 | 0.82 |

^{a}CON = Control; Bio = Biolite included in diet at 1.25% of DM; Mix = Biolite and Brucite included in diet at 0.75 and 0.50% of diet DM, respectively; and RT = Monensin sodium and Tylosin phosphate included in diet at 30 and 10 g/ton, respectively.
^{b}Standard error of least squares mean, n = 4 replications per treatment.
^{c}Probability of a larger calculated F value.
^{def}Least squares means with a common superscript do not differ statistically.

### C. The Effects of Biolite® (A Calcium Clinoptilolite Zeolite) And Brucite on Microbial Metabolism in Continuous Culture of Rumen Contents

### i. Introduction

This study was comprised of three treatments which are identified in the following manner:

Control

Control+Biolite® (“B”)

Control+Biolite®R+Brucite (“BB”)

### ii. Procedures

The composition and analyses of the rations are shown in Table C-1. Analysis of the forage is found in Appendix Table C-6.

TABLE C-1
Diet Composition and Analysis, % Dry Matter Basis (“DMB)

| | Treatment Diets | | |
|---|---|---|---|
| | Control | B | BB |
| Component | | | |
| Grass Hay | 50.0 | 50.0 | 50.0 |
| Yellow Corn | 8.5 | 7.5 | 7.5 |
| Bakery Product | 32.0 | 32.0 | 32.0 |
| Gluten Feed | 7.5 | 7.5 | 7.5 |
| Premix Supplement | 2.0 | 2.0 | 2.0 |
| Biolite | 0.0 | 1.0 | 0.665 |
| Brucite | 0.0 | 0.0 | 0.333 |
| Analysis: | | | |
| Crude Protein | 12.4 | 12.3 | 12.3 |
| Soluble Protein (% CP) | 40.8 | 41.1 | 38.9 |
| NDF | 34.5 | 33.0 | 35.3 |
| ADF | 19.7 | 18.7 | 18.9 |
| NSC¹ | 32.5 | 28.9 | 29.7 |
| Starch | 22.4 | 19.1 | 19.6 |
| Sugar | 10.2 | 9.8 | 10.1 |
| Ether Extract | 4.3 | 4.2 | 3.9 |
| Ash | 8.0 | 8.8 | 9.0 |
| NFC² | 40.8 | 41.7 | 39.5 |

¹Nonstructural Carbohydrate (starch + sugar)
²Calculated Non-Fiber Carbohydrate

All treatments were fermented in duplicate for nine days in continuous cultures, with effluent samples for analyses composited over the last three days. Continuous culture conditions were as follows:

| | |
|---|---|
| Liquid dilution rate | 9%/hr |
| Solids Retention Time | 33 hr |
| Feed Intake | 40 g DM/d |
| Feeding Frequency | 2x/day at 12 hr intervals |
| Fermentation temperature | 39° C. |
| pH | Recorded at 0.5 hr intervals |

Statistical Analyses—Treatment effects were analyzed using the General Linear Model.

Procedures of SAS. A Duncan's Multiple Range Test at the 5% level of probability was used also to detect differences among treatments.

### iii. Results

Digestion coefficients are shown in Table C-2. The treatments had no effect on digestion of fiber when measured as either acid detergent fiber (ADF) or neutral detergent fiber (NDF). Both treatments tended to reduce digestion of the non-structural carbohydrate (NSC) fraction (P+0.10). The reduction in g of NSC digested, which includes starch and sugar, caused a significant (P+0.05) decrease in g total carbohydrate digested on the B treatment. Digestion of other components was not affected by either treatment.

TABLE C-2
Digestion Coefficients for Dry and Organic Matter, Crude Protein,
Fiber and Nonstructural Carbohydrates

| | Treatments | | | Trt Effect |
|---|---|---|---|---|
| Item | Control | B | BB | P = |
| Digestion, % | | | | |
| Dry Matter | 50.2 | 55.9 | 53.8 | 0.80 |
| Organic Matter | 43.4 | 45.3 | 44.7 | 0.34 |
| Crude Protein | 45.5 | 49.5 | 48.2 | 0.41 |
| NDF | 42.6 | 42.3 | 44.1 | 0.73 |
| ADF | 46.9 | 46.9 | 44.5 | 0.57 |
| NSC¹ | 78.1^{a} | 76.6^{a,b} | 75.7^{b} | 0.10 |
| Total Carbohydrate², g/d | 16.0^{a} | 14.4^{b} | 15.2^{a,b} | 0.05 |

¹Nonstructural Carbohydrate, includes sugar and starch.
²g NDF + g Nonstructural carbohydrate digested per day.
^{a,b}Values with different superscripts differ, P < .05

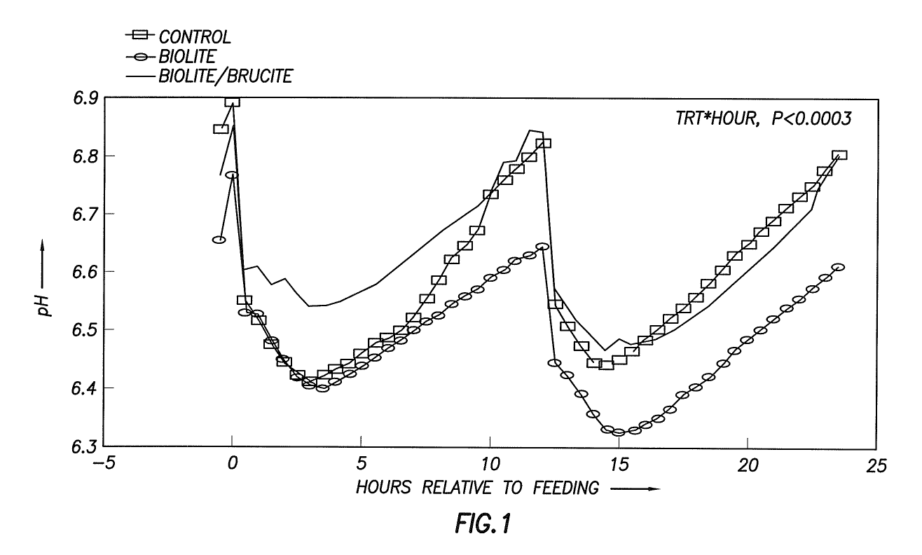

Production and molar ratios of volatile fatty acids (VFA), as well as average daily fermentation pH, are shown in Table C-3. No treatment effect on production of total VFA was found; however treatment B tended to decrease, and BB to increase, the mMoles of propionic acid produced/day (P=0.07). Isobutyrate production was significantly increased (P=0.03) by BB, while B alone had no effect. These VFA production responses resulted in a tendency (P=0.18) for B to reduce and BB to increase the molar proportion of propionate. The molar proportion of butyrate was significantly increased by B and decreased by BB (P=0.02). The average daily pH was not affected by the treatments. As shown in FIG. 1 however, the B treatment appears to have caused a somewhat lower pH post-feeding than did either BB or the control. Also, the increase in pH that started about 3 hours after feeding was at a significantly slower rate for B than for the control, as indicated by the significant hour x treatment interaction (P=0.0003).

TABLE B-3
Volatile Fatty Acid (VFA) Production, Molar Ratios and
Average Daily Fermenter pH

| | Treatments | | | Trt Effect |
|---|---|---|---|---|
| Item | Control | B | BB | P = |
| Total VFA, | 170 | 167^{a} | 169 | 0.93 |
| mmoles/d | | | | |
| Molar %: | | | | |
| Acetic | 65.4 | 64.4 | 63.5 | 0.55 |
| Propionic | 21.7 | 20.9 | 22.6 | 0.51 |
| Isobutyric | 0.44 | 0.36 | 0.47 | 0.18 |
| Butyric | 0.0^{b} | 10.4^{a} | 9.7^{c} | 0.02 |
| Isovaleric | 0.25 | 0.13 | 0.21 | 0.63 |
| Valeric | 3.2 | 3.8 | 3.6 | 0.85 |
| A-P Ratio | 2.98 | 3.08 | 2.82 | 0.48 |
| Mmoles/day: | | | | |
| Acetic | 109 | 108 | 107 | 0.94 |
| Propionic | 37^{a,b} | 35^{b} | 38^{a} | 0.07 |
| Isobutyric | 0.60^{b} | 0.60^{b} | 0.79^{a} | 0.03 |
| Butyric | 14 | 17 | 16 | 0.34 |
| Isovaleric | 0.32 | 0.22 | 0.36 | 0.68 |
| Valeric | 4.4 | 6.3 | 6.1 | 0.64 |
| Average pH | 6.59 | 6.49 | 6.62 | 0.28 |

^{a,b,c}Values with different superscripts differ, P < .05

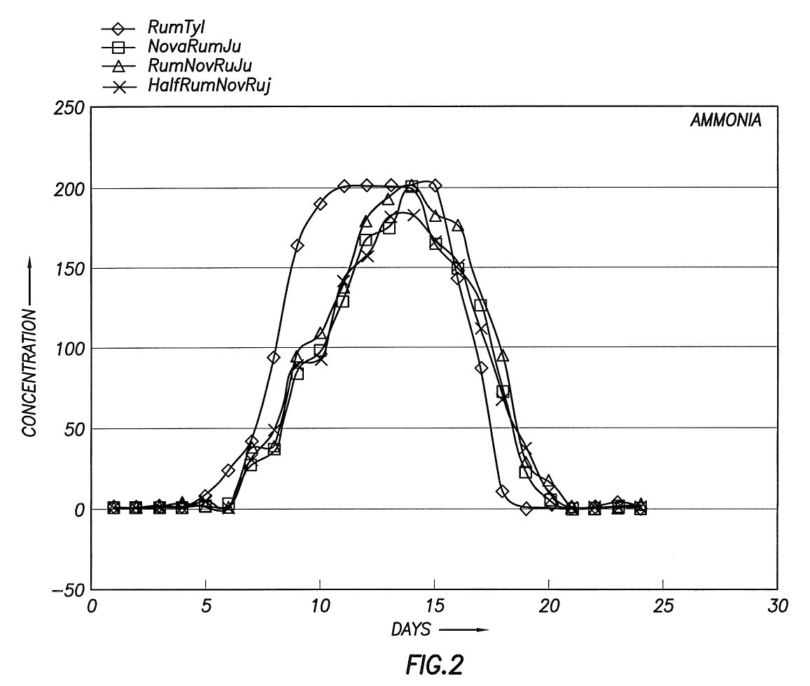

FIG. 2 is a chart of lagoon ammonia emissions showing that the Rumensin®-Tylan® (“RumTy”) diet without the inclusion of zeolite released more ammonia quicker than any of the following diets: (a) a diet with calcium clinoptilolite zeolite (Biolite®) and Nova-Cell® and Ruma-Just® (“NovaRumJu”) but without any Rumennsin®-Tylan®; (b) a diet with calcium clinoptilolite zeolite (Biolite®) and with Rumensin, Nova-Cell®, and Ruma-Just® (“RumNovRuJu”) but without any Tylan®; and (c) a diet a diet with calcium clinoptilolite zeolite (Biolite®), and with a half-concentration of Rumensin®, Nova-Cell® and Ruma-Just® (“HalfRumNovRu”) but without any Tylan®. Partition of nitrogen, microbial growth and microbial efficiencies are shown in Table C-4. Production of Microbial N was marginally increased by both treatments (P=0.13), with B having a greater positive effect than BB. Compared to the control, treatment B resulted in somewhat higher digestion of protein, followed by treatment BB. Of the resultant increases in N available for microbial use. B lost less as ammonia and allowed more for microbial growth than did BB. This is reflected in the higher efficiency of conversion of feed N to microbial N for B than for BB or the control. Treatment B also significantly (P+0.10) increased microbial efficiency as measured by microbial N produced/kg of either OM or carbohydrate digested. In addition, B tended to cause the production of more VFA/kg carbohydrate digested and less VFA/kg microbes than the control or BB.

TABLE C-4
Nitrogen Partitioning, Microbial Growth and Microbial Efficiency

| | Treatments | | | Trt Effect |
|---|---|---|---|---|
| Item | Control | B | BB | P = |
| CP digested, % | 45.4 | 49.5 | 48.2 | 0.41 |
| Non-ammonia N, g/d | 0.95 | 0.97 | 0.95 | 0.54 |
| Ammonia N, mg/dl | 3.03 | 2.12 | 3.17 | 0.26 |
| ByPass N, g/d | 0.56 | 0.52 | 0.53 | 0.38 |
| Microbial N, g/d | 0.39 | 0.45 | 0.42 | 0.13 |
| Efficiencies: | | | | |
| Mic.N/kg DMD¹ | 19.6 | 20.6 | 19.3 | 0.83 |
| Mic.N/kg OMD² | 24.5^{b} | 27.3^{a} | 25.6^{a,b} | 0.10 |
| Mic.N/kg CHOD³ | 24.4^{b} | 31.3^{a} | 27.4^{a,b} | 0.10 |
| Feed N, %⁵ | 84.4 | 89.4 | 84.4 | 0.18 |
| TVFA/kg CHOD⁶ | 6.82 | 7.45 | 7.06 | 0.36 |
| TVFA/kg Mic N⁷ | 286 | 241 | 270 | 0.20 |

¹Grams Microbial N produced per kg dry mater digested.
²Grams Microbial N produced per kg total organic matter digested.
³Grams Microbial N produced per kg total carbohydrate digested.
⁴Digested feed N converted to microbial N, %.
⁵Moles VFA produced/kg carbohydrate digested.
⁶Moles VFA produced/kg Microbial N produced.
^{a,b}Values with different superscripts differ, P < .05.

Table C-5 shows the partial composition of the microbes. The significantly lower RNA-N in the microbes cultured on the B treatment is indicative of a change in the major species on that treatment compared to the control or BB treatment.

TABLE C-5
Effects of Treatments on the Composition of the Microbes

| | Treatments | | | Trt Effect |
|---|---|---|---|---|
| Item | Control | B | BB | P = |
| Nitrogen, % | 8.56 | 8.58 | 8.64 | 0.90 |
| Ash, % | 19.08 | 28.52 | 20.51 | 0.18 |
| RNA-N, % Total N | 36.23^{a} | 32.77^{b} | 35.16^{a,b} | 0.05 |

^{a,b}Values with different superscripts differ, P < .05

### iv. Discussion

Although there was a significant decrease in g total carbohydrate digested on the B treatment, little of the decrease was due to the effects of the treatment on the digestion coefficients. Nearly all of the decrease was in the NSC fraction, and while the NSC digestibility was slightly reduced by the treatments, most of the reduction in g of NSC digested was the result of replacing the corn in the diets with B or BB. The quantities of NSC in the diets, as seen in Table B-1, clearly show this. The lower percent of NSC in diet B likely explain the lower amount of propionate produced on that diet.

There were, however, some interesting responses to the treatments, particularly treatment B. In spite of having less NSC digested than the control or BB, treatment B appears to have resulted in more vigorous fermentation, as indicated by the prolonged low pH after feeding. In addition, protein metabolism appears to have been altered by treatment B. This treatment had higher microbial growth than the control a slightly higher growth than did treatment BB. It also resulted in the least loss of N as ammonia.

The energy to support microbial growth is virtually all from the digestion of carbohydrates. The greater amount of microbial growth on B was accomplished with the least quantity of digested carbohydrate. This was a consequence of the significantly higher microbial efficiency, i.e., g microbial N/kg carbohydrate digested, as seen on this treatment. This was an increase in efficiency of 28% over that of the control. If a response of this magnitude could be verified in further experiments, especially in diets of lactating cows, it would establish Biolite as a major amendment to ruminant rations. Concomitant with the increase in microbial efficiency, treatment B also had the highest conversion of feed N to microbial N and the least VA/kg microbes grown. The latter indicates a tendency to direct nutrients toward microbial growth rather than to VFA production.

The positive effects of B on N metabolism could have resulted from modifications in the metabolism of the microbes or from a change in microbial species. Table B-5 does show a significant reduction in RNA-N in the microbial mass on treatment B, which would support the concept of a change in predominant species on this treatment.

Treatment BB generally gave results intermediate to those of the control and B. This could mean that the Bruciate was simply acting as a diluent to the more effective Biolite.

### v. Conclusions

1. The treatments had little effect on the digestion of nutrients or on the production of VFA.

2. Treatment B tended to increase microbial growth and decrease loss of N as ammonia when compared to the control.

3. Treatment B significantly increased the microbial N produced/unit of both OM and carbohydrate digested.

4. Treatment BB produced responses intermediate to those of the control and treatment B.

5. The 28% increase I microbial N produced/kg carbohydrate digested on treatment B was the most important finding in this trial, and bears further investigation with different diets and levels of Biolite.

APPENDIX TABLE C-6.
Forage Analysis, % Dry Matter Basis

| Ingredient | Grass Hay |
|---|---|
| Component: | |
| Dry Matter | 90.0 |
| Crude Protein | 9.6 |
| Soluble, % CP | 27.1 |
| ADICP, % CP | 7.7 |
| NDICP, % CP | 33.3 |
| NDF | 52.7 |
| Lignin, % NDF | 3.7 |
| ADF | 32.0 |
| NSC | 11.4 |
| Starch | 0.0 |
| Sugar | 11.4 |
| Ether Extract | 3.0 |
| Ash | 8.9 |
| NFC¹ | 25.8 |

¹Calculated Non-Fiber Carbohydrate

### D. Comparing Monensin Sodium-Tylosin Phosphate to Nova-Cell in a Restricted Fed Grow Program (with & without Biolite®)

### i. Introduction

Monensin sodium and Tylosin phosphate (“RT”) have been the standard feed additives for beef cattle rations for approximately 30 years. However, some recent research has indicated that RT may be less effective in modern rations than when first introduced. Furthermore, natural beef produced by cattle receiving diets containing no drug additives is increasing in popularity.

The purpose of this trial will be to compare RT and non-drug diets containing a microbial, Nova-Cell (“NC”). In addition, Biolite® (“BL”) a calcium clinoptilolite zeolite which has been shown to reduce subclinical acidosis and improve performance in natural diets will be compared with RT & NC diets.

The experimental design is shown in Table D-1. The experimental grow ration and premix are shown in Tables D-2 and D-3, respectively. Tables D-4 and D-5 contain performance, economic data, and health observations.

### ii. Experimental Animals & Data Collected

The experimental animals were Char-Hereford cross unweaned heifer calves originating from Western Ontario and Eastern Manitoba Canada. On arrival they were vaccinated for IBR, PI3 and BVD. They were treated for internal and external parasites with Ivomec. They were implanted with Synovex C.

Approximately 350 head of calves were purchased weighing approximately 500 lbs. From this group 160 head and were selected for the experiment and randomly allotted into four experimental groups. Each treatment contains 5 reps of 8 head each. They were grown on a medium energy level diet limit fed calculated to obtain a daily gain of approximately 2.6 lbs. Length of feeding period will be approximately 100 days. After arrival and prior to the trial allotment they were each-backgrounded for approximately 3-4 weeks. They averaged approximately 550 lbs at the beginning of the trial.

Data collected included:
1. Gain, consumption and conversions at 28 day intervals and overall.
2. Observations on bloat and metabolic problems.
3. Cost of gain by treatment including feed and feed additive cost, with no yardage or “mark up”.

### iii. Result and Discussion

Based on estimated energy content of the ration the cattle were limit fed to gain of 2.6 lbs. throughout the trial, the calves in each of the treatments exceeded the projected gain.

Originally the trial was scheduled for 100 days, but because of unusually good performance, it was decided to terminate at 91 days. Performance data including gain, consumption and conversions plus the statistical analysis is shown in Tables D-4 & D-5.

In addition to performance, gain cost was estimated based on the ingredient cost plus the cost of the additives. The feed additive costs used are as follows:

| Ration Cost/lb DM | $/hd/dy |
|---|---|
| Microbial Cost | 0.008 |
| Biolite ® Cost* | 0.005 |
| Monensin sodium | 0.025 |
| Tylosin phosphate | 0.012 |

*Biolite ® cost calculated based on its costs less the cost of grain it replaced

Treatment 2 which contained the NC plus BL gained more rapidly, consumed more feed and converted better than the other treatments. There were no other significant performance differences.

Gain cost was the lowest for treatment 2. It should be pointed out that these costs are for ration ingredient cost plus additives, but do not contain any mark up for milling or yardage.

Table D-5 contains a summarized performance for NC vs RT and BL vs non-BL treatments. Cattle receiving NC gained more rapidly and consumed more feed than cattle receiving RT. There were no significant differences in conversions. Cattle fed BL gained more rapidly and converted more efficiently than those which didn't receive BL.

As one might expect, bloat problems were relatively minor which is normal for a small pen experimental studies. However, it is interesting to note that there were no cattle treated for bloat and no bloat deads in Treatments 1 & 2.

### iv. Summary

Diets containing NC plus BL performed better than diets containing NC alone or RT diets. There was no difference in performance between in cattle receiving NC alone, or RT or RT and BL.

TABLE D-1A
Experimental Design
Treatments*

| | |
|---|---|
| 1. | Microbial (Nova-Cell) |
| 2. | Nova-Cell + Biolite |
| 3. | Monensin sodium − Tylosin phosphate |
| 4. | Monensin sodium − Tylosin phosphate + Biolite ® |

TABLE D-2A
Experimental Limit Fed Grow Ration

| | D.M.B. |
|---|---|
| Ingredients | |
| Corn (82% D.M.) | 58.0% |
| Wet Brewers Grain (30% D.M.) | 15.00 |
| Corn Silage (30% D.M.) | 20.00 |
| Premix | 07.00 |
| | 100.0% |
| ESTIMATED ANALYSIS (D.M.B) | |
| Protein (%) | 13.50 |
| NPN (%) | 03.00 |
| Fat (%) | 03.50 |
| Fiber (%) | 09.80 |
| Calcium (%) | 00.68 |
| Phosphorus (%) | 00.40 |
| NE m (megacals) | 81.70 |
| NE p (megacals) | 49.50 |

BL added at 1.2% (D.M.B) in place of corn in experimental diets

TABLE D-3A
EXPERIMENTAL GROW PREMIX

| | Amount | |
|---|---|---|
| Ingredients | | |
| Wheat Shorts | 56.0% | |
| Limestone | 20.00 | |
| Urea | 15.00 | |
| Salt | 04.00 | |
| Potassium Chloride | 04.00 | |
| Dical Phosphate | 00.00 | |
| Mag. Oxide | 01.00 | |
| Ammonium Sulfate | 00.00 | |
| | 100.0% | |
| Additives | | |
| Vitamin A | 40,000 | IU/lb. |
| Vitamin D | 4,000 | IU/lb. |
| Vitamin E | 40 | IU/lb. |
| Selenium | 2.0 | mg/lb. |
| Trace Mineral Premix* | 6 | lb/ton |

*Trace Mineral Premix

| | |
|---|---|
| Zinc Sulfate | 59.3% |
| Manganese Sulfate | 20.30 |
| Copper Sulfate | 18.80 |
| Cobalt | 01.20 |
| EDDI | 00.40 |
| | 100.0% |

TABLE D-4A
Effect of Treatment on Grow Performance

| | NC | NC + BL | RT | RT + BL |
|---|---|---|---|---|
| ADG | 2.85b | 3.21α | 2.83b | 2.87b |
| Consumption | 17.0αb | 17.3α | 16.9αb | 16.7b |
| Conversions | 5.97b | 5.43α | 5.97b | 5.80αb |
| Gain Cost (¢/lb) | 37.7 | 35.6 | 38.3 | 37.0 |
| Bloat Treated | 0 | 0 | 0 | 0 |
| Bloat Died | 0 | 0 | 2 | 1 |

TABLE D-5A
Non-Medicated vs. Medicated and Biolite vs. No Biolite

| | NC | RT | BL | NO BL |
|---|---|---|---|---|
| ADG | 3.03α | 2.85b | 3.04b | 2.84b |
| Consumption | 17.11α | 16.77b | 16.97 | 16.91 |
| Conversions | 5.70 | 5.84 | 5.62α | 5.96b |

### E. Comparing Monensin Sodium-Tylosin Phosphate or Aueromycin® to Nova-Cell in a Finish Ration Program

### i. Introduction

Natural beef programs using rations without ionophores or antibiotics are increasing in popularity. Furthermore, research and field observations suggests that with continuing to use, low level ionophores and some antibiotics have become less effective.

The purpose of this trial was to compare Nova-Cell which is a non-drug microbial to Monensin sodium-Tylosin phosphate and Aueromycin® drug additive treatments. An additional treatment using Monensin sodium only Tylosin phosphate fed at 30 grams level initially and then at a reduced level (15 grams/ton) in the final feeding phase will also be tested.

Previous research has also indicated that Biolite® which is a non-drug additive may improve animal performance, especially in diets which do not contain drug additives. In the Nova—Cell, Monensin sodium-Tylosin phosphate and Aueromycin® treatments, treatments with and without Biolite® will be studied.

### ii. Experimental Animals & Data Collected

The experimental animals will be Char-Hereford cross heifers which were grown on a limit fed program in a previous experiment. The heifers were originally from Western Ontario and Eastern and Manitoba Canada and were limit fed for 91 days. At the beginning of this finish trial, the animals were re-implanted with Revalor H. The finish ration formula and premix are shown in Table E-2 & D-3. The finish ration was a high concentrate steam flaked corn diet which also contained 20% (DMB) wet distillers grains.

The experimental design in shown in Table E-1. The three main treatments contain 10 reps of 8 head each while the fourth treatment contains 5 reps/head. In each of the first three main treatments, there were Biolite® and no Biolite® sub-treatments of 5 reps each.

The cattle were check weighed at 28 day intervals with a pencil 4% shrink. Originally the cattle were to be fed for 112 days, but because they preformed extremely well, it was decided to terminate the trial at 100 days.

Observations, including occurrence of metabolic disorders and bloat. Rumen pH samples were collected at approximately midpoint in the finish period from animals in each treatment. The end of the 100 day feeding period, the cattle were “harvested” at the nearby Excel packing plant. Carcass data including quality grade, dressing percent and liver abscesses was collected by the packing plant staff.

TABLE E-1
Experimental Design
Treatments*

| | |
|---|---|
| 1. | Microbial (Nova-Cell) (with &without Biolite ® sub-treatments) |
| 2. | Monensin sodium (30 grams) Tylosin phosphate (with &without |
| | Biolite ® sub-treatments) |
| 3. | Aueromycin ® (350 mg) (with &without Biolite ® sub-treatments) |
| * | Monensin sodium (30 grams) (with &Without |
| | Biolite ® sub-treatments) |
| | 10 Reps of 8 head each/treatment (5 reps/sub-treatment) |
| * | Monensin sodium decreased to 15 grams @ day 56 |

TABLE E-2
Experimental Finish Ration
Finish Ration
D.M.B

| INGREDIENTS | |
|---|---|
| Steam Flaked Corn (82% D.M.) | 68.0% |
| Wet Corn Distillers Grain (30% D.M.) | 20.00 |
| Corn Silage (30% D.M.) | 06.00 |
| Premix | 06.00 |
| | 100.0% |
| ESTIMATED ANALYSIS (D.M.B) | |
| Protein (%) | 14.00 |
| NPN (%) | 02.00 |
| Fat (%) | 04.50 |
| Fiber (%) | 05.20 |
| Calcium (%) | 00.61 |
| Phosphorus (%) | 00.35 |
| NE m (megacals) | 105.60 |
| NE p (megacals) | 66.00 |

*BL added at 1.2% (D.M.B) in place of corn in experimental diets

TABLE E-3
EXPERIMENTAL PREMIX

| | Amount | |
|---|---|---|
| Ingredients | | |
| Wheat Shorts | 52.7% | |
| Limestone | 25.00 | |
| Urea | 11.70 | |
| Salt | 04.10 | |
| Potassium Chloride | 05.00 | |
| Dical Phosphate | 00.00 | |
| Mag. Oxide | 01.50 | |
| Ammonium Sulfate | 00.00 | |
| | 100.0% | |
| Additives | | |
| Vitamin A | 40,000 | IU/lb.. |
| Vitamin D | 4,000 | IU/lb. |
| Vitamin E | 40 | IU/lb. |
| Selenium | 2.0 | mg/lb. |
| Trace Mineral Premix* | 6 | lb/ton |

*Trace Mineral Premix

| | |
|---|---|
| Zinc Sulfate | 59.3% |
| Manganese Sulfate | 20.30 |
| Copper Sulfate | 18.80 |
| Cobalt | 01.20 |
| EDDI | 00.40 |
| | 100.0% |

### F. Comparing Nova-Cell® & Ruma-Just® in Non-Medicated (Natural) Diets to Monensin Sodium-Tylosin Phosphate Diets (Diets with or without Biolite®)

### i. Introduction

Previous research has indicated that natural products such as Nova-Cell® (a microbial strain of Lactobacillus Acidophilus NCFM) and Biolite® (a calcium clinoptilolite zeolite) may be added to rations in place of low level drug additives and help maintain acceptable performance. “Ruma-Just” is an extract from the yucca schidigera plant which is also has been used as non-drug feed additive. It may improve performance because of the saponins content which apparently suppresses rumen protozoa. It is believed this anti-protozoa activity improves rumen microbial efficiency. Ruma-Just® may also depress ammonia production and loss. Previous work has indicated that Biolite® reduced manure nitrogen loss probably because of it's affinity for ammonia. Ammonia emissions may be a major problem in confined feeding operations.

In the following trial performance on rations containing Monensin sodium-Tylosin phosphate was compared to non-drug rations containing Ruma-Just® and Nova-Cell®. The effect of Biolite® in each of these diets will also be measured.

In addition to performance data, the impact of additives on feedlot metabolic problems such as bloat was observed. At approximately midpoint of feeding trial, the impact of diet on rumen pH and also on ammonia loss from experimental lagoons was measured.

### ii. Experimental Animal And Data Collected

The experimental animals were English cross yearling steers and heifers of Northern Ontario origin. Upon arrival at the feedyard the yearlings received Revalor S or Revalor H implants and routine vaccination for IBR, PI3 and BVD. They were treated for internal and external parasites using Ivomec.

There were four main experimental treatments each containing 10 pens/reps of 8 head each. There were 6 pens of steers and 4 pens of heifers in each treatment. In addition, there were Biolite® and non-Biolite sub-treatments of 5 reps within each main treatment. The experimental treatments are shown in Table F-1 and the ration and premix in Tables F-2 and F-3.

The cattle were check weighed at 28 day intervals using a morning gross weight less a 4% pencil shrink. The length of the trial was 100 days. At harvest the cattle were shipped to the nearby Excel packing plant where carcasses data including dressing percentage, quality grade and liver abscesses was collected.

### iii. Results & Discussion

The performance data in Tables F-4 and F-4A was analyzed two ways. First, the performance of all 8 treatments was analyzed separately (Table F-4) and second, the main treatments were combined and analyzed (Table F-4A).

The best gain and conversions were in Treatment 4 with Biolite® (BL). The 15 gm Monensin sodium level with Biolite® has also proven effective in a previous study is currently in use at several feedyards. The next best performance from both a gain and conversion standpoint was in treatment 1 with BL and treatment 2 without BL. The estimated gain cost for the treatments is based on the feed additive cost shown in Table F-6, plus a ration cost of $180/ton (DMB). The lowest gain cost was for treatment 4 with BL followed by treatment 2 without BL. The gain cost advantage for these two treatments relates not only to conversions, but to the lower feed additive costs.

Table F-4A shows the overall performance for the combined 4 main treatments plus the overall performance comparing the BL to no-BL rations. In these comparisons, the only significant performance difference was the lower conversion for the BL verses the non-BL cattle.

Carcass data is shown in Table F-5 and there were no significant treatment differences. The dressing percents and quality grades would be considered adequate for this type of cattle and days on feed. There were no lung lesions which indicated good overall health on the cattle. Liver abscess condemnations were relatively low and more important, there were no A+ abscesses in any of the treatments. This would indicate that the addition of Tylosin phosphate was not necessary for liver abscess control. No unusual metabolic problems were observed in any treatments.

Rumen pH measures are shown in Table F-7. As in previous experiments, Rumen ph was significantly higher for the BL verses the non BL cattle. Perhaps the most interesting pH observation is the relatively high pH for treatment 2 without BL. This may be a partial explanation for the excellent performance of this treatment.

Lagoon ammonia emissions are shown in Table F-8 and FIG. 2. Ammonia emissions from manure from the BL rations were lower compared to treatment 1 without BL. This is most likely due to the affinity of BL for ammonia. Lagoon and feedlot ammonia emissions may become increasingly important as research at Texas A&M indicates that feedlots of 5,000 head capacity or greater emit excess ammonia relative to current EPA Standards.

### iv. Summary

The results of these trials indicate rations containing Nova-Cell and Ruma-Just can give comparable or better performance to rations containing Monensin sodium-Tylosin phosphate. Cattle on a ration with Nova Cell and Ruma-Just® plus Monensin sodium at 15 gm and BL gave the best performance.

TABLE F-1
Experimental Design
Treatments*

| | |
|---|---|
| 1. | Monensin sodium (30 grams) Tylosin phosphate (with & |
| | without Biolite ® sub-treatment) |
| 2. | Ruma Just ® + Nova-Cell (with & without Biolite ® sub-treatment) |
| 3. | Monensin sodium (30 grams) + Nova-Cell + Ruma |
| | Just ® (with & without Biolite ® sub-treatment) |
| 4. | Monensin sodium (15 grams) + Nova-Cell + Ruma |
| | Just ® (with & without Biolite ® sub-treatment) |

*10 reps of 8 head each/Main Treatment & 5 Reps/sub-treatment

TABLE F-2
Experimental Finish Ration
Finish Ration

| | D.M.B |
|---|---|
| Ingredients | |
| Steam Flaked Corn (82% D.M.) | 68.0% |
| Wet Corn Distillers Grain (30% D.M.) | 20.00 |
| Corn Silage (30% D.M.) | 06.00 |
| Premix | 06.00 |
| | 100.0% |
| Estimated Analysis (D.M.B) | |
| Protein (%) | 14.00 |
| NPN (%) | 02.00 |
| Fat (%) | 04.50 |
| Fiber (%) | 05.20 |
| Calcium (%) | 00.61 |
| Phosphorus (%) | 00.35 |
| NE m (megacals) | 105.60 |
| NE p (megacals) | 66.00 |

*BL added at 1.2% (D.M.B) in place of corn in experimental diets

TABLE F-3
Experimental Premix

| Ingredients | Amount |
|---|---|
| Wheat Shorts | 57.6% |
| Limestone | 22.10 |
| Urea | 11.30 |
| Salt | 04.00 |
| Potassium Chloride | 04.00 |
| Dical Phosphate | 00.00 |
| Mag. Oxide | 01.00 |
| Ammonium Sulfate | 00.00 |
| | 100.0% |

TABLE F-4
Performance Data
Individual Treatment Comparisons

| | With Biolite ® | | | | | Without Biolite ® | | | |
|---|---|---|---|---|---|---|---|---|---|
| Treatment | 1 | 2 | 3 | 4 | | 1 | 2 | 3 | 4 |
| ADG | 3.52^{ab} | 3.53^{ab} | 3.36^{b} | 3.86a | — | 3.39^{b} | 3.67^{ab} | 3.49^{b} | 3.42^{b} |
| Consumption | 21.6 | 22.8 | 21.4 | 22.7 | — | 22.6 | 22.8 | 22.3 | 22.3 |
| Conversion | 6.16^{ab} | 6.47^{a} | 6.38^{a} | 5.59^{b} | — | 6.65^{a} | 6.23^{ab} | 6.41^{a} | 6.54^{a} |
| Gain Cost (See | $56.67 | $59.01 | $60.79 | $54.07 | | $61.18 | $56.82 | $60.57 | $60.04 |
| Table G-6) | | | | | | | | | |

WO common subscripts differ @ P < .05

TABLE F-4A
Combined Treatment Comparisons
Overall

Treatment

| | 1 | 2 | 3 | 4 |
|---|---|---|---|---|
| ADG | 3.46 | 3.60 | 3.43 | 3.64 |
| Consumption | 22.1 | 22.8 | 21.9 | 22.5 |
| Conversion | 6.41 | 6.35 | 6.79 | 6.21 |

Overall

| | Biolite ® | Without Biolite ® |
|---|---|---|
| ADG | 3.57 | 3.49 |
| Consumption | 22.1 | 22.5 |
| Conversion | 6.2^{a} | 6.5^{b} |

Significant difference @ P < .08

TABLE F-5
Carcass Data

Treatment

| | 1 | 2 | 3 | 4 |
|---|---|---|---|---|
| Dressing %* | 63.5 | 63.5 | 63.7 | 63.6 |
| Choice & Prime % | 61.0 | 54.0 | 56.0 | 57.0 |
| Liver Abscesses (A −) %** | 8.7 | 13.9 | 16.5 | 8.9 |
| Lung Lesions*** | 0 | 0 | 0 | 0 |

*Canadian yields + 4%
**No A+ Liver Abscesses
***No Lung Lesions
No significant differences in carcass traits

TABLE F-6
Ration Feed Additive Costs ($/ton)*

Treatment

| | 1 | 2 | 3 | 4 |
|---|---|---|---|---|
| Monensin sodium (30 gm/ton | 2.55 | -0- | 2.55 | -0- |
| Monensin sodium 15 gm/ton | -0- | -0- | -0- | 1.28 |
| Tylosin phosphate | 1.50 | -0- | -0- | -0- |
| Ruma-Just ® (1 gm/hd/dy) | -0- | 1.63 | 1.63 | 1.63 |
| Nova-Cell ® (50 mg/hd/dy | -0- | 0.72 | 0.72 | 0.72 |
| Total Cost ($) | 4.05 | 2.35 | 4.90 | 3.63 |

*at current corn price, cost of Biolite ® is zero Ration cost $180/ton (DMB)

TABLE F-7
Rumen pH*

| Treatment | Overall | BL | No-BL |
|---|---|---|---|
| 1 | 6.36^{bc} | 6.4 | 6.22 |
| 2 | 6.52^{a} | 6.59 | 6.45 |
| 3 | 6.34^{c} | 6.47 | 6.21 |
| 4 | 6.49^{a} | 6.52 | 6.46 |

| | Overall |
|---|---|
| Biolite ® | 6.50^{a} |
| Non-Biolite | 6.34^{b} |

*Rumen samples taken with Geishauser Probe AM prior to feeding

TABLE F-8
Effect of Diet on Lagoon Ammonia Emission (ppm)

| | Treatment | | | |
|---|---|---|---|---|
| | | | 3 | |
| | 1 (WO BL) | 2 (W BL) | (W BL) | 4 (W BL) |
| Total Daily Experiment | 1758^{a} | 1452^{b} | 1620^{ab} | 1462^{b} |
| (24 day) | | | | |
| Average Emissions | 73 | 61 | 68 | 61 |
| (Daily) | | | | |
| Days Exceeding 200 | 5 | 1 | 1 | -0- |
| ppm | | | | |

### G. The Effect of Monensin Sodium & Tylosin Phosphate & a Zeolite Buffer on the Performance of Calves Fed a 40% (DMB) Wet Distillers Grains Finish Diet

### i. Introduction

The most significant event in agriculture in the 1^{st} decade of the 21^{st} century has been the tremendous increase in fuel ethanol production produced from corn. In 2006 5.4 billion gallons of ethanol was produced in the United States (US) and by 2009, it is estimated to 11.6 billion gallons/year will be produced. The US government has set a goal of 35 billion gallons of bio-fuel production as part of an effort to reduce gasoline usage 20% by 2017.

Approximately 2.7 gallons of ethanol is produced per bushel of corn. After the ethonal is produced, approximately 30% of the original dry matter (DM) ends up as either wet or dried distiller's grains (DG). The DG can be fed to cattle in either the wet or dry form, but feeding it wet eliminates the cost of drying. The wet product normal contains 30 to 35% DM and can be used directly in cattle rations.

Distillers grains are of greater value in cattle rations compared to poultry or swine because the cattle can better utilize the fiber and type of protein in DG. Recent research has indicated that Monensin sodium & Tylosin phosphate may not give a beneficial performance response in high concentrate diets containing flaked corn and DG. The reason may relate to the high sulfur (S) content of DG and the possibility that Monensin sodium may increase the production of hydrogen sulfide from S in the rumen (3). Hydrogen sulfide is thought to be a more toxic form of S in the rumen. It is speculated rations with S levels in excess of 0.3% may reduce the performance and possibly cause metabolic problems. It is thought that high S levels reduce rumen motility thus increasing bloat and digestive problems. It has also been suggested that by increasing rumen pH, the negative impact of high S levels may be decreased. The purpose of this study was to compare Monensin sodium & Tylosin phosphate added at either the 30 gm Monensin sodium level, 15 gm or 0 Monensin sodium to rations with or without a rumen buffer (Biolite®). The level of the wet distillers grains (WDGS) in the diet was 40% (DMB). The WDGS replaced corn and part of the supplemental protein in the diets.

### ii. Materials & Methods

The experimental animals were Angus cross steer and heifer calves from Manitoba, Canada. They were trucked to the experimental feedlot located near Kitchener, Ontario, Canada. On arrival of the animal received IBR, PIP and BVD vaccine plus Covexina. They were also treated for internal and external parasites with Ivomec pour on. Prior to the beginning of this trial the calves were preconditioned for approximately 45 days and adapted to a high concentrate diet.

### iii. Experimental Design & Data Collected

Following the preconditioning period, unhealthy calves were removed and the remaining calves were divided into steer and heifer groups. These groups were then divided at random into 20 pens of steers and 20 pens of heifers. Each of the pens contained 8 head of calves. Five pens of steers and 5 pens of heifers were then allotted to each of 4 experimental treatments.

The experimental treatments are shown in Table G-1. Initial, 28 day interim weights and final weights were based on gross weights less a 4% pencil shrink. Experimental data collected included average daily gain, feed consumption and feed conversions. In addition, death loss and bloat problems were observed. At the termination of the trial, Rumen pH was measured on 4 animals from each treatment using a Geishauser Probe. The pH measurements were taken at 2, 4 and 6 hours after feeding.

A calcium clinoptilolite zeolite (Biolite®) was added in place of an equivalent amount of corn. In treatments 2, 3 and 4 which contained Biolite® the level fed was either 1.25% or 2.50% (DMB).

### iv. Results and Discussion

Originally it had been planned to conduct a 120 day trial. However, because of the metabolic problems and bloat deads in 2 of the treatments, it was decided to terminate the trial at 84 days. It should be noted that metabolic problems in small experimental pens is relatively unusual. The number of treated and deads was greater in treatments 1 and 2 as compared to treatments 3 and 4. Because treatments 1 and 2 contained the 30 grams Monensin sodium level compared to 15 grams of Monensin sodium in treatment 3 or 0 Monensin sodium in treatment 4, this was unexpected. One can speculate that these metabolic problems may be related to the high S levels in this diet. Some research has shown that the addition of Monensin sodium to high S diets increases the formation of hydrogen sulfide in the rumen (4). Also, it is speculated that a higher rumen pH which were found in treatments 3 and 4 may reduce the formation of hydrogen sulfide.

Some research indicates that low rumen pH and high rumen S levels may decrease ruminal motility. This decreased ruminal motility may be responsible for increase gas accumulation in the rumen and bloat.

Average daily gain (deads out) was higher in treatment 4 as compared to treatments 1, 2 and 3. Deads in, average daily gain for treatments 1 and 2 was lower than treatments 3 and 4. Consumption did not differ by treatment, but there was a trend for improved conversions in treatment 4.

Rumen pH was higher in treatment 4 compared to treatment 1. Previous studies have also indicated that the addition of Biolite® results in an increase in rumen pH.

Doubling the Biolite® level from the normal 1.25% (DMB) to 2.5% did not affect performance. However, in areas where Biolite® may be less expensive on a DMB compared to the corn, adding the additional Biolite® in place of corn could reduce ration and gain costs. Previous studies have shown that performance of cattle on rations containing Biolite® alone (Treatment 4) may be better than compared to rations with Monensin sodium & Tylosin phosphate (RT) (Treatment 1). However, the increased metabolic treatments and death loss in Treatment 1 which contained the high R level was somewhat unexpected. In more conventional rations, Monensin sodium levels are sometimes increased as a method of controlling metabolic problems including bloat. Previous research and field observations have indicated that the Biolite® does reduce metabolic problems under feedlot conditions. It is possible that the high S levels in these diets may be related to the metabolic problems and the lack of response from the Monensin sodium. Calculated S levels in these diets would be approximately 0.4% which would be higher than the maximum 0.3% suggested by the NRC. Previous research from Zinn et al (5) had indicated that in some diets S levels over 0.2% may reduce performance. Beede (1) reported subclinical S toxicity in diets containing over 0.4% S. Pritchard (4) suggests that low rumen pH favors a formation of Hydrogen sulfide and low rumen pH plus high Hydrogen sulfide levels may reduce rumen motility and thereby increase bloat problems. Certain zeolites have been shown to bind S but it is not known if this occurs in conditions that are found in the rumen. However, several studies have indicated that Biolite® increases rumen pH and if higher rumen pH levels decrease the production of hydrogen sulfide and Monensin sodium levels increase hydrogen sulfide production, this may be at least a partial explanation for the results seen in this trial.

### v. Summary

Results of this trial indicate that satisfactory performance can be obtained when replacing steam flaked corn with high levels of WDGS (40% DMB). However, there were more bloat and metabolic problems in rations which contained a high level of Monensin sodium. Adding Biolite® without Monensin sodium increased rumen pH, daily gain and reduced metabolic problems.

### LITERATURE CITED

1) Beede, Dave, 1999. Excess Dietary Sulfur: A problem?
2) Gould, Daniel H. 1998. Polioencephalomalacia
3) Kung, L. Kung, J. P. Bracht, J. Y. Tavares. 1999. Effect of Various Compounds on in vitro ruminal fermentation and production of sulfide.
4) Pritchard, R. H. Corn Byproducts: Considerations Involving Sulfur
5) Zinn, R. A., E. Alvarez, M. Montano and E. Ramirez. 1999. Toxic Effects of high Dietary Sulfur on Growth Performance of Feedlot Calves During The Early Growing Phase.

TABLE G-1
Experimental Design
Treatments

| | |
|---|---|
| 1) | Monensin sodium (30 grams) + Tylosin phosphate |
| 2) | Monensin sodium (30 grams) + Tylosin phosphate + Biolite ® |
| 3) | Monensin sodium (15 grams) + no Tylosin phosphate + Biolite ® |
| 4) | Biolite ® Only |

10 Pens Reps of 8 head each/Treatment

TABLE G-2
EXPERIMENTAL HIGH LEVEL WDGS DIET

| | DMB | AS FED |
|---|---|---|
| Ingredients | | |
| Flaked Corn | 44.0% | 24.0% |
| Wet Distillers Grain (32% DM) | 40.00 | 58.00 |
| Corn Silages (32.5% DM) | 10.00 | 15.00 |
| Premix | 06.00 | 03.00 |
| | 100.0% | 100.0% |
| Estimated Analysis (D. M. B) | | |
| Protein (%) | 16.00 | |
| NPN (%) | 02.00 | |
| Fat (%) | 05.70 | |
| Fiber (%) | 05.50 | |
| Calcium (%) | 00.66 | |
| Phosphorus (%) | 00.33 | |
| NE m (megacals) | 96.30 | |
| NE p (megacals) | 60.00 | |
| Dry Matter | 100.00 | 46.9% |

TABLE G-3
EXPERIMENTAL PREMIX

| | Amount | |
|---|---|---|
| Ingredients | | |
| Wheat Shorts | 60.7% | |
| Limestone | 22.50 | |
| Urea | 05.80 | |
| Salt | 05.00 | |
| Potassium Chloride | 05.00 | |
| Dical Phosphate | 00.00 | |
| Mag. Oxide | 01.00 | |
| Ammonium Sulfate | 00.00 | |
| | 100.0% | |
| Additives | | |
| Vitamin A | 40,000 | IU/lb. |
| Vitamin D | 4,000 | IU/lb. |
| Vitamin E | 40 | IU/lb. |
| Selenium | 2.0 | mg/lb. |
| Trace Mineral Premix* | 6 | lb/ton |

*Trace Mineral Premix

| | |
|---|---|
| Zinc Sulfate | 59.3% |
| Manganese Sulfate | 20.30 |
| Copper Sulfate | 18.80 |
| Cobalt | 01.20 |
| EDDI | 00.40 |
| | 100.0% |

TABLE G-4
Performance Results
84 Day Finish Trial
40% (DMB) Wet Distillers

| | Treatment 1 | Treatment 2 | Treatment 3 | Treatment 4 |
|---|---|---|---|---|
| ADG | 3.19¹ (2.71)* | 3.13¹ (2.86)* | 3.17¹ (3.03)* | 3.31² (3.31)* |
| Consumption | 18.81 | 18.49 | 18.75 | 18.37 |
| Conversion | 5.92 | 5.92 | 5.94 | 5.55 |
| Rumen pH | 6.60² | 6.71^{1,2} | 6.80^{1,2} | 6.98¹ |
| Metabolics | 11 | 9 | 4 | 4 |
| Treated | | | | |
| Deads** | 4 | 2 | 1 | 0 |
| Initial Wt. | 667 | 666 | 664 | 665 |
| Final Wt. | 935 | 929 | 930 | 944 |

Performance calculated with deads out
*Gain with deads in
1 & 2 within rows treatment with difference
superscript differ (P < .10)
**Significantly fewer metabolics treated and
deads in Treatment 3 & 4 compared to Treatments
1 & 2 (P < .05)

Biolite ® Level Comparison

| | 1.25% Biolite ® | 2.5% Biolite ® |
|---|---|---|
| ADG | 3.18 | 3.22 |
| Consumption | 18.61 | 18.46 |
| Conversion | 5.88 | 5.75 |

### H. Supplementing Winter Forage Minerals with Zeolite

### i. Introduction

One normally does not expect low rumen pH on cattle grazing on forage, but some winter forage, such as wheat pasture, is so digestible and high in nutrient density that it differs from other grasses. For example, the very high protein content of wheat pasture (typically in the range of 20-35%) means that there is likely to be excess ammonia produced at the rumen level. It is now believed that low rumen pH on cattle grazing wheat pastures is a major portion of the bloat and metabolic death loss problem. Further, some wheat pastures are high in sulfur content, which may also cause metabolic problems in ruminants. It is now thought that the bloat in ruminants allowed to feed on winter forage, especially wheat pasture, is at least partially related to these factors. It is now thought that a zeolite, preferably a clinoptilolite zeolite, should help reduce this problem of bloat and metabolic death loss.

### ii. Results and Discussion

Preliminary data and recent anecdotal testing indicate that a zeolite added to a winter forage diet will increase rumen pH. These also indicate that a zeolite added to a winter forage diet will decrease ruminal ammonia levels. Data disclosed herein indicates that a zeolite also reduces sulfur toxicity in a ruminant. Further, data disclosed herein also indicates that a zeolite can reduce or eliminate the need for otherwise routinely used antibiotics in a ruminant diet.

In general, the zeolite is preferably a clinoptilolite, and most preferably calcium clinoptilolite, such as Biolate® calcium clinoptilolite. The zeolite is preferably provided to the ruminant in a mineral supplement at a concentration of at least 10% by weight on a dry matter basis. More preferably, the zeolite is in a mineral supplement for the range of 10%-50% by weight on a dry matter basis. The mineral supplement can be in any convenient form, such as loose granular form, pelletized form, or block form. Preferably, the mineral supplement is in a loose granular form. Preferably, the ruminant is allowed fi-ee-choice access to the mineral supplement.

According to this invention, a method of feeding a ruminant is provided. The method includes the steps of: (a) providing a ruminant a grazing time on a winter forage; and (b) during the grazing time, providing the ruminant a mineral supplement comprising a zeolite.

The step of providing a ruminant a grazing time on a winter forage typically includes: introducing the ruminant to a winter forage and allowing the ruminant to graze on the winter forage.

According to the invention, a typical grazing time is at least 50 days. A typical grazing time is in the range of 50-150 days.

According to one aspect of this invention, the method the winter forage has a sulfur content greater than 0.3% by weight on a dry matter basis. This can be the case, for example, where the winter forage includes wheat pasture. A typical grazing time on such winter forage is at least 50 days.

According to the method, regardless of sulfur content, the winter forage includes wheat pasture. For example, the winter forage can include at least 50% wheat pasture. The method of this invention is particularly advantageous where the winter forage consists essentially of wheat pasture. A typical grazing time on a winter forage including wheat pasture is at least 50 days.

According to advantageous embodiments of this invention, during the grazing time at least 50% of the ruminant diet on a dry matter basis is derived from grazing on the winter forage. More typically, during the grazing time substantially all of the ruminant diet is derived from grazing on the winter forage. Typically, the grazing time on the winter forage is at least 50 days.

The method according to Claim 1, wherein the step of providing a mineral supplement comprises providing the mineral supplement to the ruminant on a fi-ee-choice basis. Typically, the mineral supplement is provided in a loose granular form. A typical mineral supplement would include, for example, limestone, dicalcium phosphate, magnesium oxide, sodium chloride, and any combination thereof in any proportion. Other ingredients can be included in the mineral supplement. A mineral supplement is typically consumed free choice by a ruminant at the rate of one-fourth to one-half pound per day.

According to this aspect of the inventions, in preferred embodiments the zeolite is present in the mineral supplement in the range of 10%-50% by weight on a dry matter basis. Preferably, the zeolite includes a clinoptilolite zeolite. More preferably, the clinoptilolite zeolite is present in the mineral supplement in the range of 10%-50% by weight on a dry matter basis. Most preferably, the zeolite includes a calcium clinoptilolite zeolite. Most preferably, the calcium clinoptilolite zeolite is present in the mineral supplement in the range of 10%-50% by weight on a dry matter basis.

According to further aspects and further preferred embodiments of this invention, during the grazing time the ruminant diet has less than FDA currently approved levels, and wherein during the grazing time the ruminant diet has less than FDA currently approved levels. (The U.S. Food and Drug Administration has approved levels for such antibiotics during animal grazing.) More preferably, during the grazing time the ruminant diet is free of monensin sodium and free of tylosin phosphate. More preferably, during the grazing time the ruminant diet is free of ionophore class antibiotic and free of macrolide class antibiotic. Most preferably, during the grazing time the ruminant diet is free of all antibiotics.

According to a more particular aspect of the method of feeding a ruminant, the method includes the steps of: (a) providing a ruminant a grazing time to graze on a winter forage; and (b) during the grazing time, providing the ruminant a mineral supplement comprising a zeolite; wherein during the grazing time at least 50% of the ruminant diet on a dry matter basis is derived from grazing on the winter forage; and wherein the zeolite comprises a clinoptilolite zeolite. A typical grazing time is at least 50 days. Preferably, the step of providing a mineral supplement includes providing the mineral supplement to the ruminant on a fi-ee-choice basis. Preferably, the mineral supplement is in loose granular form. According to this aspect, the clinoptilolite zeolite is preferably present in the mineral supplement in the range of 10%-50% by weight on a dry matter basis. According to a further embodiment of this method, during the grazing time the ruminant diet has less than FDA currently approved levels, and wherein during the grazing time the ruminant diet has less than FDA currently approved levels.

Therefore, the present inventions are well adapted to attain the ends and advantages mentioned as well as those which are inherent therein. While the invention has been depicted, described, and is defined by reference to exemplary embodiments of the inventions, such a reference does not imply a limitation on the inventions, and no such limitation is to be inferred. The inventions are capable of considerable modification, alteration, and equivalents in form and function, as will occur to those ordinarily skilled in the pertinent arts and having the benefit of this disclosure. The depicted and described embodiments of the inventions are exemplary only, and are not exhaustive of the scope of the inventions. Numerous combinations and subcombinations of the exemplary data and examples in this disclosure are contemplated. Consequently, the inventions are intended to be limited only by the spirit and scope of the appended claims, giving full cognizance to equivalents in all respects.

What is claimed is:

1. A method of feeding a ruminants the method comprising the steps of:
(a) providing a ruminant a grazing time on a winter forage; and
(b) during the grazing time, providing the ruminant a mineral supplement comprising a zeolite.

2. The method according to claim 1, wherein the step of providing a ruminant a grazing time on a winter forage comprises: introducing the ruminant to a winter forage and allowing the ruminant to graze on the winter forage.

3. The method according to claim 1, wherein the grazing time is at least 50 days.

4. The method according to claim 1, wherein the winter forage has a sulfur content greater than 0.3% by weight on a dry matter basis.

5. The method according to claim 4, wherein the winter forage comprises wheat pasture.

6. The method according to claim 4, wherein the grazing time is at least 50 days.

7. The method according to claim 1, wherein the winter forage comprises wheat pasture.

8. The method according to claim 1, wherein the winter forage comprises at least 50% wheat pasture.

9. The method according to claim 8, wherein the winter forage consists essentially of wheat pasture.

10. The method according to claim 8, wherein the grazing time is at least 50 days.

11. The method according to claim 1, 4, or 8, wherein during the grazing time at least 50% of the ruminant diet on a dry matter basis is derived from grazing on the winter forage.

12. The method according to claim 11, wherein the grazing time is at least 50 days.

13. The method according to claim 1, wherein the step of providing a mineral supplement comprises providing the mineral supplement to the ruminant on a free-choice basis.

14. The method according to claim 1, wherein the zeolite is present in the mineral supplement in the range of 10%-50% by weight on a dry matter basis.

15. The method according to claim 1, 4, or 8, wherein the zeolite comprises a clinoptilolite zeolite.

16. The method according to claim 15, wherein the clinoptilolite zeolite is present in the mineral supplement in the range of 10%-50% by weight on a dry matter basis.

17. The method according to claim 1, wherein the zeolite comprises a calcium clinoptilolite zeolite.

18. The method according to claim 1, 4, or 8, wherein during the grazing time the ruminant diet has less than FDA currently approved levels, and wherein during the grazing time the ruminant diet has less than FDA currently approved levels.

19. The method according to claim 1, wherein during the grazing time the ruminant diet is free of monensin sodium and free of tylosin phosphate.

20. The method according to claim 1, wherein during the grazing time the ruminant diet is free of ionophore class antibiotic and free of macrolide class antibiotic.

21. The method according to claim 1, wherein during the grazing time the ruminant diet is free of all antibiotics.

22. A method of feeding a ruminant, the method comprising the steps of:
(a) providing a ruminant a grazing time to graze on a winter forage; and
(b) during the grazing time, providing the ruminant a mineral supplement comprising a zeolite:
wherein during the grazing time at least 50% of the ruminant diet on a dry matter basis is derived from grazing on the winter forage; and
wherein the zeolite comprises a clinoptilolite zeolite.

23. The method according to claim 22, wherein the grazing time is at least 50 days.

24. The method according to claim 22, wherein the step of providing a mineral supplement comprises providing the mineral supplement to the ruminant on a free-choice basis.

25. The method according to claim 22, wherein the clinoptilolite zeolite is present in the mineral supplement in the range of 10%-50% by weight on a dry matter basis.

26. The method according to claim 25, wherein during the grazing time the ruminant diet has less than FDA currently approved levels, and wherein during the grazing time the ruminant diet has less than FDA currently approved levels.
